(19) United States
(12) Patent Application Publication
(10) Pub. No.: US 2026/0354657 A1
(43) Pub. Date: Nov. 12, 2026

(54) STONE MAT

(71) Applicant: Luxx One, LLC, Mililani, HI (US)

(72) Inventor: Brendan YORITA, Honolulu, HI (US)

(21) Appl. No.: 19/199,387

(22) Filed: May 6, 2025

(51) Int. Cl. A47L 19/02; A47G 27/02; B32B 37/24

(52) U.S. Cl. CPC A47L 19/02; A47G 27/0206; B32B 37/24; B32B 2471/04; B32B 2475/00

(57) ABSTRACT

A stone mat is provided. In embodiments, the stone mat includes a grip surface; a moisture absorbing surface on the grip surface; and a plurality of stone sections adhered on the moisture absorbing surface.

### BACKGROUND

Aspects of the present invention relate generally to a stone mat and, more particularly, to a stone mat which includes a plurality of stone sections, a grip surface, and a moisture absorbing surface.

### SUMMARY

In a first embodiment, a stone mat includes a grip surface; a moisture absorbing surface on the grip surface; and a plurality of stone sections adhered on the moisture absorbing surface.

In a second embodiment, a stone mat includes a grip surface; a moisture absorbing surface on the grip surface; and a plurality of rectangular stone sections adhered on the moisture absorbing surface with at least one groove between the plurality of rectangular stone sections.

In a third embodiment, a method of fabricating a stone mat includes providing a grip surface; depositing a moisture absorbing surface on the grip surface; and adhering a plurality of diatomaceous earth stone sections of the moisture absorbing surface with at least one groove between the plurality of diatomaceous earth stone sections. In the third embodiment, the at least one groove prevents pooling of water on the stone mate, and the grip surface provides a non-slip surface with a strong grip.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a first structure of a stone mat according to embodiments of the present invention.

FIG. 2 depicts the first structure of the stone mat according to embodiments of the present invention.

FIG. 3 depicts the first structure of the stone mat according to embodiments of the present invention.

FIG. 4 depicts the first structure of the stone mat according to embodiments of the present invention.

FIG. 5 depicts the first structure of the stone mat according to embodiments of the present invention.

FIG. 6 depicts a second structure of the stone mat according to embodiments of the present invention.

FIG. 7 depicts the second structure of the stone mat according to embodiments of the present invention.

FIG. 8 depicts the second structure of the stone mat according to embodiments of the present invention.

FIG. 9 is a flowchart of fabricating the stone mat according to embodiments of the present invention.

### DETAILED DESCRIPTION

Aspects of the present invention relate generally to a stone mat and, more particularly, to a stone mat which includes a plurality of stone sections, a grip surface, and a moisture absorbing surface. Embodiments of the present inventions also include natural diatomaceous earth within each of the plurality of stone sections of the stone mat. Accordingly, the stone mat of the present invention absorbs water and moisture quickly and remains dry. In further embodiments, the stone mat of the present invention absorbs water and moisture in a predetermined time, such as less than one minute. In aspects of the present invention, the stone mat absorbs water and moisture in the predetermined time such that the stone mat remains dry to prevent mold and bacteria growth.

In further aspects of the present invention, each of the plurality of stone sections of the stone mat comprise rectangular sections of natural diatomaceous earth which are attached to a moisture absorbing surface. In an example, the moisture absorbing surface comprises a faux suede surface (i.e., a leathaire fabric surface). In embodiments, the faux suede surface provides for a quick drying soft surface which helps absorb water and moisture. In further embodiments, the moisture absorbing surface is also attached to a grip surface. In embodiments, the faux suede surface enhances a bonding function to the plurality of stone sections and the grip surface. In particular, the faux suede surface allows for the bonding function to integrate the plurality of stone sections, a plurality of grooves, and the grip surface together in one cohesive and functional stone mat. In aspects of the present invention, the grip surface provides a non-slip surface with a strong grip. Accordingly, the stone mat including the plurality of stone sections, the grip surface, and the moisture absorbing surface allows the stone mat to be flexible and foldable. In further embodiments of the present invention, the faux suede surface (i.e., the leathaire fabric surface) comprise synthetic materials which are designed to mimic the texture, function, and appearance of leather or suede.

In embodiments of the present invention, the grip surface comprises a non-slip or friction-enhancing surface. In further embodiments of the present invention, the grip surface may include rubber or other materials, such as elastomers, polymers, or textured materials designed to prevent movement or enhance grip on smooth and wet surfaces. In an example, the grip surface comprises at least one of rubber (including natural rubber, nitrile rubber, or synthetic rubber variants), silicone, thermoplastic elastomers (TPE), thermoplastic rubber (TPR), thermoplastic polyurethane (TPU), ethylene-vinyl acetate (EVA), polyurethane (PU), foamed polyvinyl chloride (PVC), neoprene, cork-rubber composites, recycled rubber, rubberized foam, textured or coated fabric with anti-slip treatment, microfiber or faux suede with rubberized backing, or other materials that could provide a non-slip purpose.

In aspects of the present invention, the moisture absorbing surface comprises alternative materials. For example, the moisture absorbing surface comprises at least one of microfiber, cotton-based fabric, terrycloth (e.g., cotton or cotton blend terrycoth), bamboo fabric, hemp fabric, jute fabric, sisal fabric, velvet, velour, chenille, fleece (e.g., polyester fleece or cotton fleece), lyocell, tencel, cotton-linen blend, micro-corduroy, quick-drying mesh fabric, and wool. In another example, the moisture absorbing surface comprises at least one of a polyurethane (PU) coated fabric, a polyvinyl chloride (PVC), a thermoplastic rubber (TPR), a textured silicone, a textured rubber, a polyester-based fabric (e.g., hydrophobic or treated), nylon, and performance fabric (e.g., Gore-Tex, etc.). In an additional example, the moisture absorbing surface comprises at least one of polyvinyl alcohol (PVA) fabric and chamois fabric. In further embodiments, PVA fabric has fast drying and absorbent properties. In aspects of the present invention, chamois fabric is highly absorbent and soft.

In aspects of the present invention, the moisture absorbing surface is stain resistant and resists mold, bacteria growth, and moisture. In embodiments of the present invention, the moisture absorbing surface is water-resistant, durable, versatile, easy to clean and maintain, ecological friendly, and cruelty free (i.e., in contrast to animal-derived leather and animal-derived suede). In further embodiments of the present invention, the moisture absorbing surface resists wear and tear and has a soft, smooth, comfortable feel and texture, while also being an effective middle layer that helps to connect the diatomaceous earth stones together in the soft mat. In further embodiments, the moisture absorbing surface is lightweight such that the stone mat has a top moisture absorbing surface connected to a bottom grip surface which adds durability to the stone mat.

In aspects of the present invention, the moisture absorbing surface and the grip surface adds weight to the stone mat to ensure that the stone mat is sturdy and safe compared to conventional mats that use a plastic material beneath the stones. In particular, conventional mats using the plastic material do not prevent warpage and do not effectively absorb moisture and water. In contrast, conventional mats merely pool the water, and thus are prone to break and peel due to not effectively absorbing moisture and water. Further, conventional mats that use the plastic material need a separate piece placed underneath stones to provide grip, which is less effective than stone mats of the present invention. In aspects of the present invention, the stone mats of the present invention provide improved grip, safety, and durability by utilizing a grip surface in comparison to conventional mats which merely use plastic material. In further embodiments of the present invention, the moisture absorbing surface is easier to clean and maintain than real leather or real suede in conventional mats. In particular, conventional mats requires special care to avoid damage from stains, moisture, or wear. In aspects of the present invention, the moisture absorbing surface is designed to be more resistant to water, stains, and wear in comparison to conventional mats. In particular, conventional mats can degrade over time if not properly and meticulously maintained. In embodiments of the present invention, the moisture absorbing surface (e.g., faux suede surface) is typically less expensive than conventional mats which include leather and suede. In further embodiments of the present invention, the moisture absorbing surface is lighter than conventional mats which include leather and suede.

In embodiments of the present invention, the stone mat includes the plurality of stone sections, the grip surface, and the moisture absorbing surface. Accordingly, the stone mat in the present invention prevents cracks, breakage, and warpage in the plurality of stone sections due to the moisture absorbing surface. In further embodiments of the present invention, a top surface of the moisture absorbing surface is designed to absorb water and moisture in grooves between each of the stone sections. Accordingly, the grooves within the top surface of the moisture absorbing surface prevents pooling of water (i.e., an accumulation of water which isn't able to be drained or absorbed) in the stone mat. Therefore, the grooves within the top surface of the moisture absorbing surface in the stone mat increase durability and longevity by preventing the pooling of water.

In aspects of the present invention, the natural diatomaceous earth within the rectangular sections of the plurality of stone sections comprise naturally occurring sedimentary rock which include microscopic and fossilized remains of single-celled creatures called diatoms. In further embodiments of the present invention, the natural diatomaceous earth is a natural, highly absorbent material made from the fossilized remains of tiny aquatic organisms called diatoms, along with recycled paper and wood shavings. In aspects of the present invention, the soft, sedimentary rock has durable moisture absorbing properties that quickly eliminate moisture, mold, and bacteria in order to keep a surface dry and clean. Accordingly, ecological friendly, non-toxic, and low maintenance diatomaceous earth prevents mold growth and maintains a clean environment with minimal effort. In embodiments, the diatoms are a type of hard-shelled microalgae that has accumulated over millions of years. In aspects of the present invention, the natural diatomaceous earth comprises a range of 80% to 90% silica, 2% to 4% alumina metals, and 0.5% to 2% iron oxide. In embodiments, the natural diatomaceous earth within the rectangular sections of the plurality of stone sections allow for the stone mat to absorb water and moisture up to four times its weight.

In embodiments, the stone mat including the plurality of stone sections, the grip surface, and the moisture absorbing surface is foldable into a cylindrical shape for easy storage. In further embodiments of the present invention, the stone mat can be used in bathrooms to absorb water from a bath or shower. In aspects of the present invention, the stone mat can also be used near the front door of the home (both inside the home and right outside of the home) to absorb moisture and water from shoes, umbrellas, and other clothes. In further embodiments of the present invention, the stone mat can be used under water bowls for pets to help absorb water and moisture. In other aspects of the present invention, the stone mat can be used under plants or other vegetation which needs water and/or moisture to survive. In embodiments of the present invention, the stone mat can be used in the kitchen under a kitchen drying rack. In other embodiments of the present invention, the stone mat can be used to place glasses, plates, kitchen utensils, etc., which have just been washed or was just removed from a dishwasher. In further embodiments, the plurality of stone sections of the stone mat can be different shapes, such as a circle, a square, a parallelogram, a polygon, a triangle, a diamond, a cylinder, a crescent, a star, a hear, an octagon, a curvilinear triangle, etc.

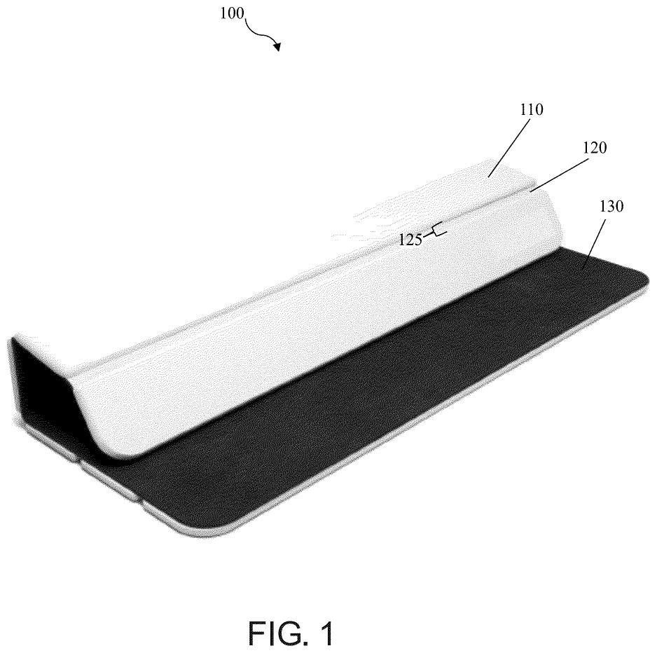

FIG. 1 depicts a first structure of a stone mat according to embodiments of the present invention. In FIG. 1, the first structure of the stone mat 100 comprises a diatomaceous earth stone section 110, a moisture absorbing surface 120, a groove 125, and a grip surface 130. In embodiments of the present invention, the first structure of the stone mat 100 comprises the grip surface 130 which is at a bottom portion of the stone mat 100. In further embodiments of the present invention, the moisture absorbing surface 120 is placed on top of the grip surface 130. In aspects of the present invention, each of the diatomaceous earth stone section 110 is placed on portions of the moisture absorbing surface 120 such that each of the grooves 125 separate each of the diatomaceous earth stone section 110 on the moisture absorbing surface 120. As described above, the moisture absorbing surface 120 comprises synthetic materials (e.g., faux suede surface) which are designed to mimic the texture, function, and appearance of leather or suede. In further embodiments, the moisture absorbing surface 120 is stain resistant and resists mold and bacteria growth. In further aspects of the present invention, the moisture absorbing surface 120 absorbs moisture. In embodiments of the present invention, the moisture absorbing surface 120 is water resistant, durable, easy to clean and maintain, ecological friendly, and cruelty free.

In aspects of the present invention, the diatomaceous earth stone section 110 absorbs water and moisture quickly (e.g., up to four times its weight) to ensure that the first structure of the stone mat 100 remains dry. In further embodiments, the diatomaceous earth stone section 110 comprises a rectangular stone section which includes naturally occurring sedimentary rock which includes microscopic and fossilized remains of single-celled creatures called diatoms. In aspects of the present invention, the naturally occurring sedimentary rock of the diatomaceous earth stone section 110 comprises a range of 80% to 90% silica, 2% to 4% alumina metals, and 0.5% to 2% iron oxide.

In embodiments of the present invention, the grip surface 130 (e.g., rubber grip surface) provides a non-slip surface with a strong grip. In further embodiments of the present invention, the diatomaceous earth stone section 110, the moisture absorbing surface 120, and the grip surface 130 of the first structure of the stone mat 100 are flexible and foldable (e.g., into a cylindrical shape).

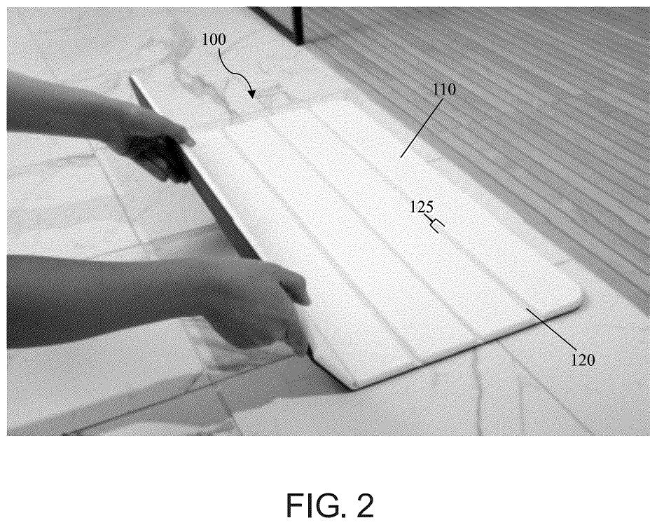

FIG. 2 depicts the first structure of the stone mat according to embodiments of the present invention. In FIG. 2, the first structure of the stone mat 100 comprises the diatomaceous earth stone section 110, the moisture absorbing surface 120, and the groove 125. In particular, FIG. 2 depicts a top view of the first structure of the stone mate 100 with a portion of the stone mat 100 being flexed.

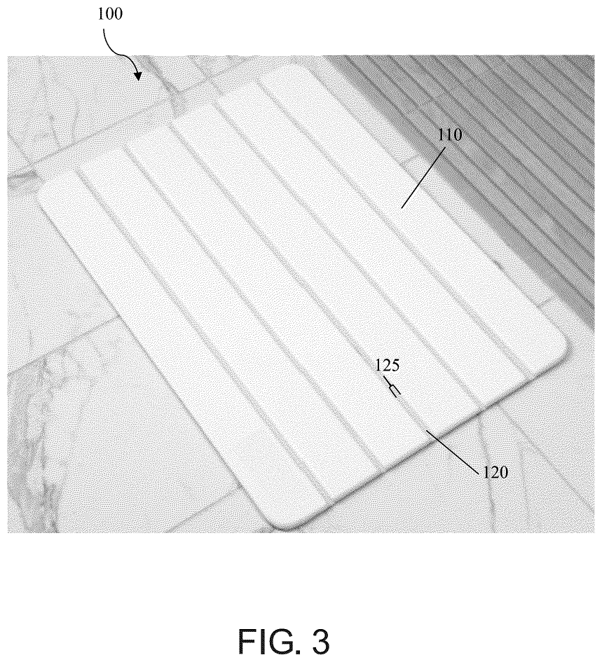

FIG. 3 depicts the first structure of the stone mat according to embodiments of the present invention. In FIG. 3, the first structure of the stone mat 100 comprises the diatomaceous earth stone section 110, the moisture absorbing surface 120, and the groove 125. In particular, FIG. 3 depicts a top view of the first structure of the stone mat 100 with the first structure of the stone mat 100 laid down completely flat.

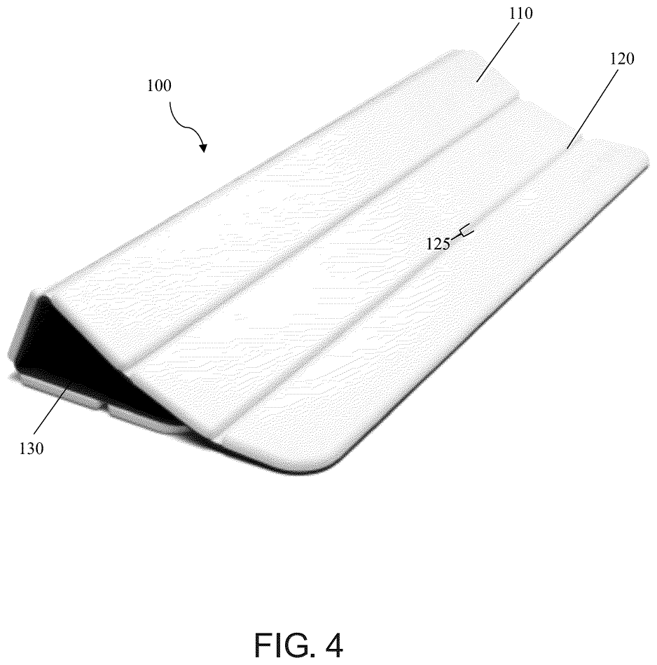

FIG. 4 depicts the first structure of the stone mat according to embodiments of the present invention. In FIG. 4, the first structure of the stone mat 100 comprises the diatomaceous earth stone section 110, the moisture absorbing surface 120, the groove 125, and the grip surface 130. In particular, FIG. 4 depicts the first structure of the stone mat 100 being folded in a flexible manner.

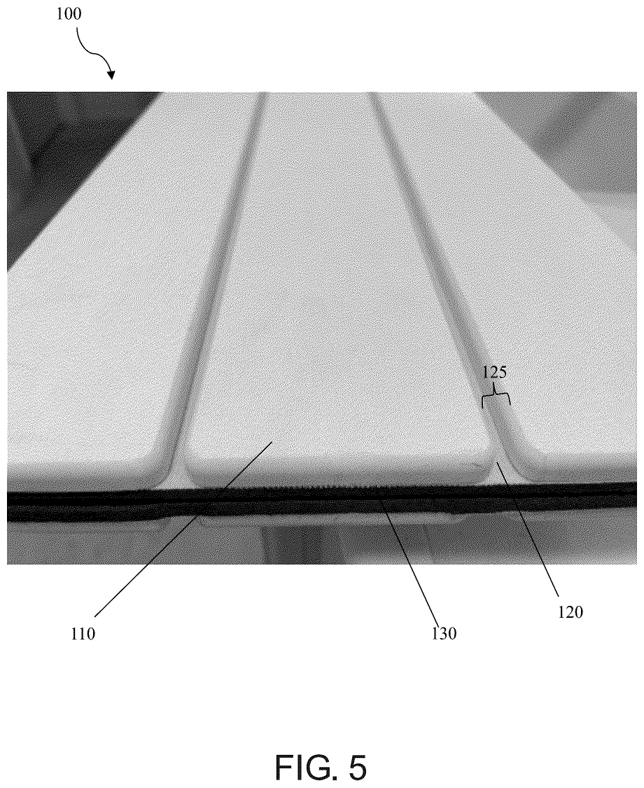

FIG. 5 depicts the first structure of the stone mat according to embodiments of the present invention. In FIG. 5, the first structure of the stone mat 100 comprises the diatomaceous earth stone section 110, the moisture absorbing surface 120, the groove 125, and the grip surface 130. In particular, FIG. 5 depicts a close up of the first structure of the stone mat 100.

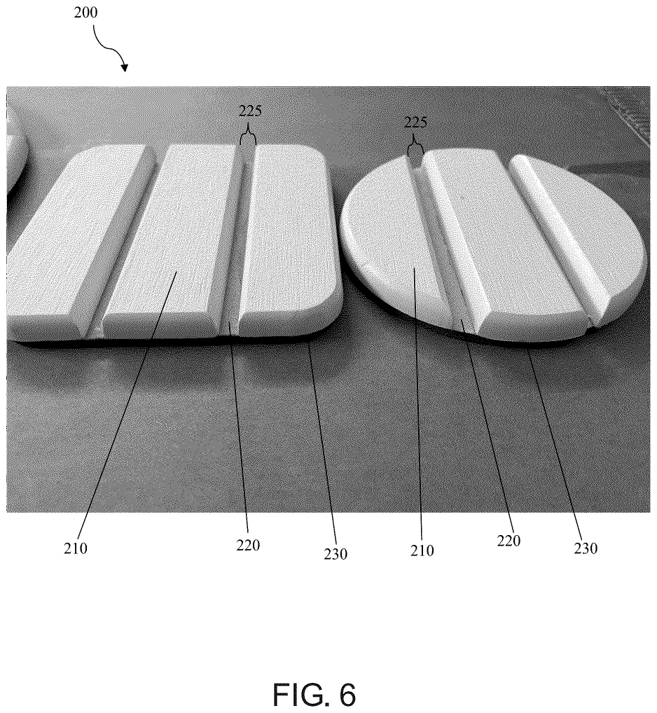

FIG. 6 depicts a second structure of the stone mat according to embodiments of the present invention. In FIG. 6, the second structure of the stone mat 200 comprises a diatomaceous earth stone section 210, a moisture absorbing surface 220, a groove 225, and a grip surface 230 (e.g., a rubber grip surface). In particular, FIG. 6 depicts the second structure of the stone mat 200 as a square and a circle. In further embodiments, the second structure of the stone mat 200 has similar advantages as the first structure of the stone mat 100 described in FIG. 1.

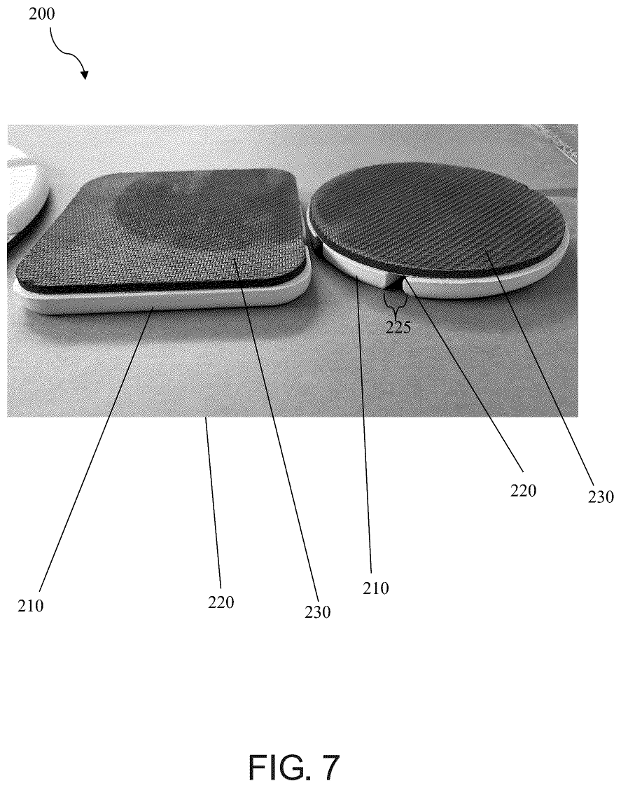

FIG. 7 depicts the second structure of the stone mat according to embodiments of the present invention. In FIG. 7, the second structure of the stone mat 200 comprises the diatomaceous earth stone section 210, the moisture absorbing surface 220, the groove 225, and the grip surface 230. In particular, FIG. 7 depicts a bottom portion of the second structure of the stone mat 200 which includes the grip surface 230.

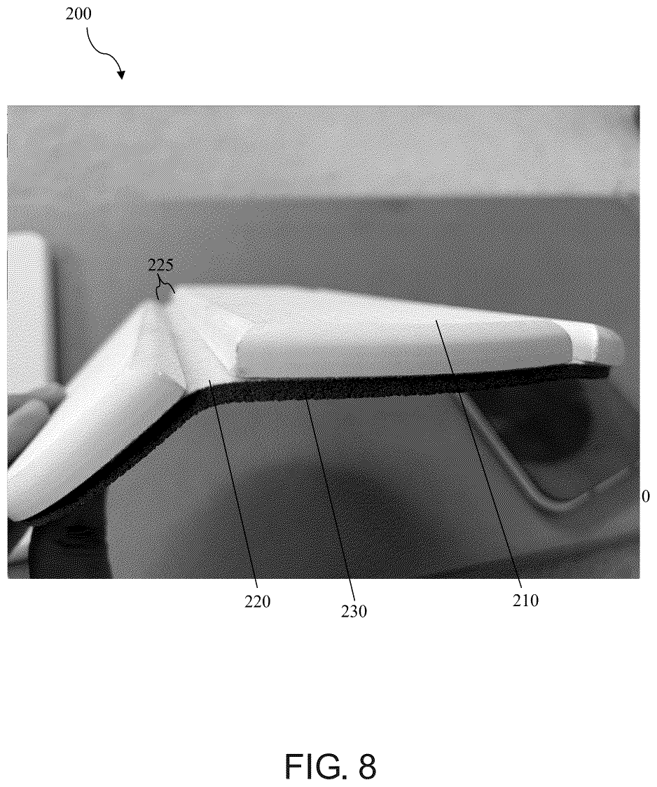

FIG. 8 depicts the second structure of the stone mat according to embodiments of the present invention. In FIG. 8, the second structure of the stone mat 200 comprises the diatomaceous earth stone section 210, the moisture absorbing surface 220, the groove 225, and the grip surface 230. In particular, FIG. 8 depicts the second structure of the stone mat 200 being flexed at the groove 225.

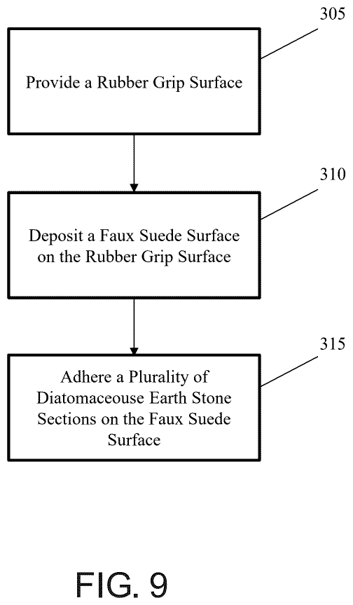

FIG. 9 is a flowchart of fabricating the stone mat according to embodiments of the present invention. FIG. 9 is described with respect to the elements described in FIG. 1. In FIG. 9, at step 905, a grip surface 130 is provided. At step 910, a moisture absorbing surface 120 (e.g., a faux suede surface) is deposited on the grip surface 130. At step 915, a plurality of diatomaceous earth stone sections 110 are adhered on and to the moisture absorbing surface 120. In further embodiments of step 915, each of the plurality of diatomaceous earth stone sections 110 are adhered on the moisture absorbing surface 120 such that a groove 125 is between and separates the plurality of diatomaceous earth stone sections 110 (as shown in FIG. 1 and corresponding portions of FIG. 1).

In aspects of the present invention, it is within the scope of the disclosure to combine any of these steps or to insulate portions of a step to accommodate available equipment or otherwise incorporate efficiency techniques to the overall fabrication of an embodiment of a box beam 10 according to the present invention, including modifications to these steps to fabricate the alternative embodiments.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A stone mat comprising:
a grip layer which comprises rubber and includes a top planar flat surface;
a moisture absorbing layer on the grip layer; and
a plurality of stone sections adhered on the moisture absorbing layer such that there is a gap between each of the plurality stone sections and a top surface of the moisture absorbing layer is exposed at the gap between each of the plurality of stone sections,
wherein the moisture absorbing layer comprises polyurethane.

2. The stone mat of claim 1, wherein the gap comprises at least one groove which separates each of the plurality of stone sections adhered on the moisture absorbing layer.

3. The stone mat of claim 2, wherein the at least one groove prevents pooling of water on the stone mat.

4. The stone mat of claim 1, wherein the grip layer provides a non-slip surface with a grip.

5. The stone mat of claim 1, wherein the plurality of stone sections, the moisture absorbing layer, and the grip layer are flexible and foldable.

6. The stone mate of claim 5, wherein the plurality of stone sections, the moisture absorbing layer, and the grip layer are flexible and foldable in a cylindrical shape for storage.

7. The stone mat of claim 1, wherein each of the plurality of stone sections comprise a rectangular stone section.

8. The stone mat of claim 7, wherein the rectangular stone section comprises a diatomaceous rectangular earth stone section.

9. The stone mat of claim 8, wherein the diatomaceous rectangular earth stone section comprises naturally occurring sedimentary rock which includes microscopic and fossilized remains of single-celled creatures called diatoms.

10. The stone mat of claim 9, wherein the diatomaceous rectangular earth stone section comprises a first weighted range of about 80% to 90% silica, a second weighted range of about 2% to 4% an alumina, and a third weighted range of about 0.5% to 2% iron oxide.

11. The stone mat of claim 1, wherein the moisture absorbing layer comprises synthetic materials which are stain resistant and resist mold and bacteria growth.

12. The stone mat of claim 1, wherein the moisture absorbing layer comprises synthetic materials which absorb water and moisture.

13. The stone mat of claim 1, wherein moisture absorbing layer comprises synthetic materials which prevent cracks, breakage, and warpage in the plurality of stone sections.

14. The stone mat of claim 1, wherein each of the plurality of stone sections is capable of absorbing water and moisture in an amount of four times its weight.

15. A stone mat comprising:
a grip layer which comprises rubber and includes a top planar flat surface;
a moisture absorbing layer on the grip layer; and
a plurality of rectangular stone sections adhered on the moisture absorbing layer with at least one groove between each of the plurality of rectangular stone sections and a top surface of the moisture absorbing layer is exposed at the at least one groove between each of the plurality of stone sections,
wherein the moisture absorbing layer comprises polyurethane.

16. The stone mat of claim 15, wherein the at least one groove prevents pooling of water on the stone mat.

17. The stone mat of claim 15, wherein each of the plurality of rectangular stone sections comprise a diatomaceous rectangular earth stone section.

18. The stone mat of claim 15, wherein the grip layer provides a non-slip surface with a grip.

19. The stone mat of claim 15, wherein the moisture absorbing layer comprises synthetic materials which absorb water and moisture.

20. A method of fabricating a stone mat, comprising:
providing a grip layer which comprises rubber and includes a top planar flat surface;
depositing a moisture absorbing layer on the grip layer; and
adhering a plurality of diatomaceous earth stone sections to the moisture absorbing layer with at least one groove between each the plurality of diatomaceous earth stone sections and a top surface of the moisture absorbing layer is exposed at the at least one groove between each of the plurality of stone sections,
wherein the at least one groove prevents pooling of water on the stone mat,
the grip layer provides a non-slip surface with a grip, and
the moisture absorbing layer comprises polyurethane.
